(19) United States
(12) Patent Application Publication
(10) Pub. No.: US 2024/0239511 A1
(43) Pub. Date: Jul. 18, 2024

(54) FIBER OPTIC ACTUATOR OVERLOAD TRIP SENSOR

(71) Applicant: Hamilton Sundstrand Corporation, Charlotte, NC (US)

(72) Inventor: Darrell E. Ankney, Dixon, IL (US)

(21) Appl. No.: 18/154,503

(22) Filed: Jan. 13, 2023

(51) Int. Cl. B64D 45/00; B64F 5/60; G01D 5/26

(52) U.S. Cl. CPC B64D 45/00; B64F 5/60; G01D 5/266; B64D 2045/0085

(57) ABSTRACT

An apparatus and a method of determining a state of an actuator in an airplane. The apparatus includes a mirror coupled to the actuator, wherein a location of the mirror is dependent on the state of the actuator, a shaft for moving the mirror upon a change in the state of the actuator, and a processor. Incident light is reflected off of the mirror to create a reflected light. The processor receives the reflected light from the mirror, detects a change in a parameter of the reflected light generated by moving of the mirror, and determines the state of the actuator based on the change in the parameter.

### CROSS-REFERENCES TO RELATED APPLICATIONS

This application claims priority to, and incorporates by reference herein in its entirety, U.S. Provisional Patent Application Ser. No. 63/316,769 (Attorney Docket No. 1610-01), filed Mar. 4, 2022.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is a photograph of a perspective view of an exemplary embodiment of a system 1000;

FIG. 2 is a photograph of a perspective view of exemplary embodiment 1000;

FIG. 3 is a photograph of a perspective view of exemplary embodiment 1000;

FIG. 4 is a photograph of a perspective view of exemplary embodiment 1000;

FIG. 5 is a photograph of a perspective view of exemplary embodiment 1000;

FIG. 6 is a photograph of a perspective view of exemplary embodiment 1000;

FIG. 7 is a photograph of a perspective view of exemplary embodiment 1000;

FIG. 8 is a photograph of a perspective view of exemplary embodiment 1000; and

FIG. 9 is a flowchart of an exemplary embodiment of a method 10000.

### DETAILED DESCRIPTION

Certain exemplary embodiments can provide a method, which comprises creating a binder. The binder comprises a plan tab, an expense tab, a design tab, a track tab, and a notes tab. A plan page adjacent to the plan tab describing considerations of garden size and soil as to a garden. The plan page recommending a user specify a size of the garden, a type of the garden, a soil descriptor, and water descriptors concerning the garden.

Certain exemplary embodiments comprise a method. The method comprises creating a binder, the binder comprising gardening materials and instructions.

Certain exemplary embodiments provide gardening methods, which methods are described in a booklet entitled “The Organized Garden Workbook” which is a vegetable garden organizer or workbook. The methods are distinguishable from a planner, day planner, journal, or expense tracker.

Certain exemplary embodiments provide methods that are specific to backyard vegetable gardening and incorporate several different sections in a specific order, which guides methods of starting, maintaining, and finishing a vegetable garden in the span of one growing year.

The methods might be described in a manner that is bound like a book, but in a three ring binder to allow the addition of blank pages for notes and the ability to three-hole punch and insert additional documentation that may come with seeds and/or plants that are utilized by a gardener.

A first section of the binder can be a planning section, which comprises methods that consider soil, sun, location, and weather that show how methods are changed based upon a specific location of the gardener. The first section of the binder can also comprise information about specific vegetables—especially those that a backyard gardener would be likely to grow.

A second section of the binder can comprise a group of expense trackers for seeds, plants, soil amendments, fertilizer, tools, equipment, and/or other supplies.

A third section of the binder can comprise graph paper and/or sample garden designs to assist with the shape and placement of a garden and plants in the garden.

A fourth section of the binder can comprise a garden specific annual monthly calendar with daily location for recording high/low temperatures, a location for tracking rainfall and/or watering schedules, and suggestions for also tracking planting schedules, harvest dates, pruning schedules, and/or first and last frost dates.

A fifth section of the binder can comprise a notes area where there are questions and/or notes to prompt the gardener. The fifth section can comprise additional areas for notes of the gardener.

A sixth section in the binder can comprise a clear three ring bound pouch large enough to store all seeds used for by the gardener for a current season.

Certain exemplary embodiments guide the gardener through gardening methods from start to finish.

Certain exemplary embodiments provide important elements in a single location and in one product and are specific to gardening. Certain exemplary embodiments provide a single location for storage of materials, paper supplies, seeds and notes so that from year to year. The gardener can look back through a binder from a prior year and see what was done in prior years.

Certain exemplary embodiments provide devices, systems, and/or methods that allow the gardener to follow gardening methods and results from year to year with tracking tools in a single location provides storage from year to year for all of such things.

Certain exemplary embodiments can be carried out into the garden for reference and documentation of what is happening. It is purposely not an app for a phone or on a computer screen. It is sturdy and can get dirty, and can be exposed to sunlight.

Certain exemplary embodiments address organizational issues that surround gardening from year to year. Certain exemplary embodiments assist with making vegetable gardening processes more logical and sequential, which makes process easier and more likely to be successful.

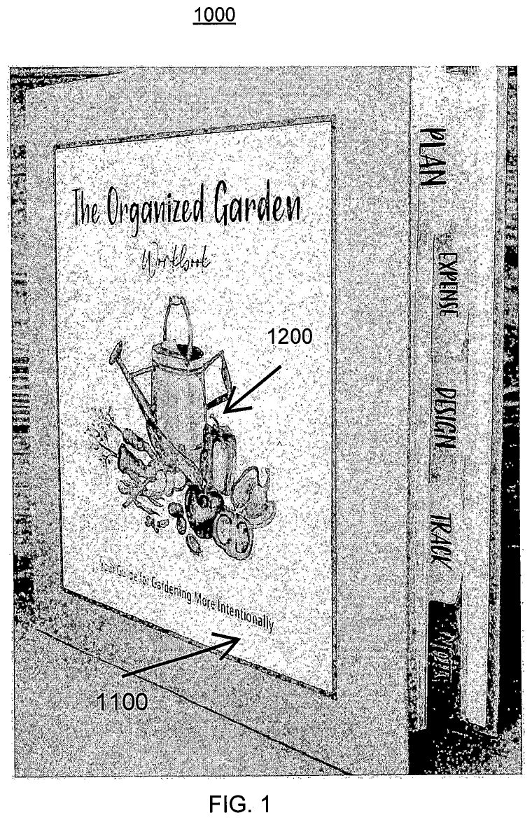

FIG. 1 is a photograph of a perspective view of an exemplary embodiment of a system 1000, which comprises a binder 1100. Binder 1100 comprises an identifier 1200.

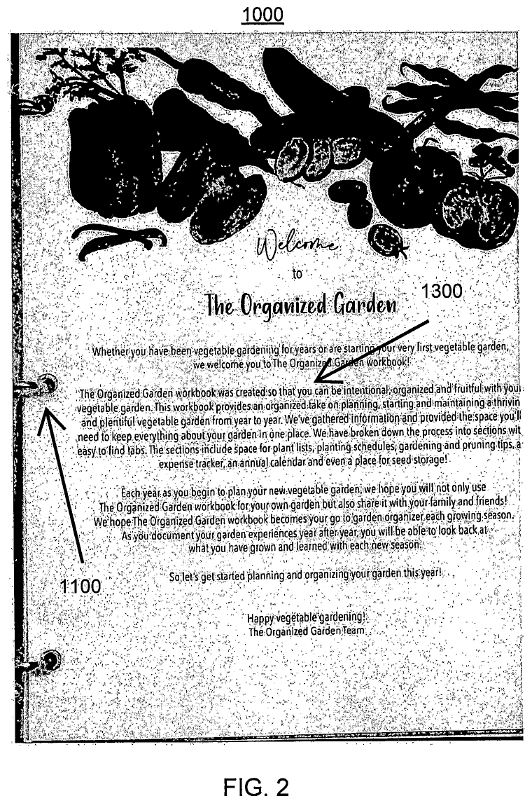

FIG. 2 is a photograph of a perspective view of exemplary embodiment 1000, which comprises a cover sheet 1300 of binder 1100. Cover sheet 1300 can provide information concerning content of binder 1100.

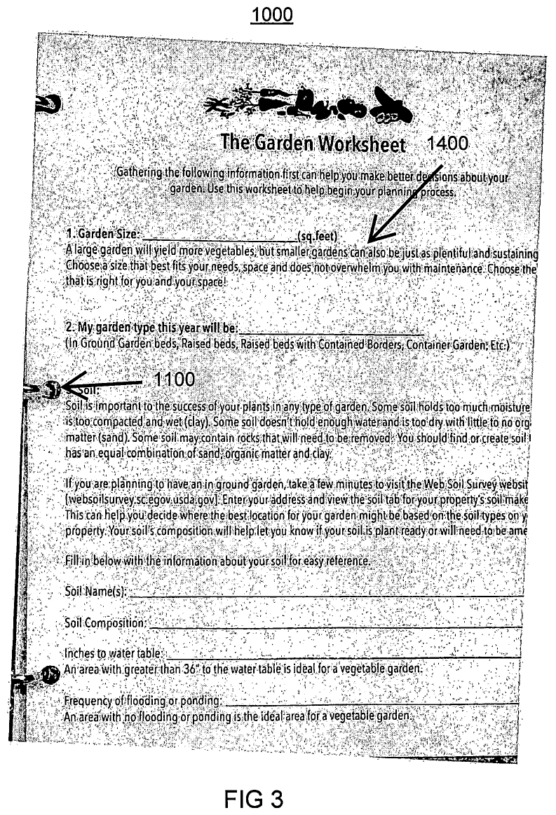

FIG. 3 is a photograph of a perspective view of exemplary embodiment 1000, which comprises a planning section 1400 of binder 1100. Planning section 1400 comprises methods that consider soil, sun, location, and weather that show how methods are changed based upon a specific location of the gardener. Planning section 1400 of binder 1100 can also comprise information about specific vegetables—especially those that a backyard gardener would be likely to grow.

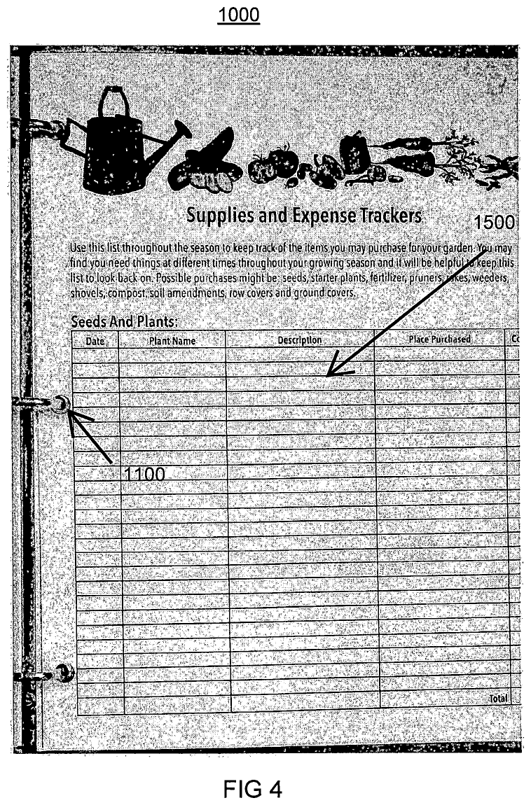

FIG. 4 is a photograph of a perspective view of exemplary embodiment 1000, which comprises a tracking section 1500 of binder 1100. Tracking section 1500 comprises a group of expense trackers for seeds, plants, soil amendments, fertilizer, tools, equipment, and/or other supplies.

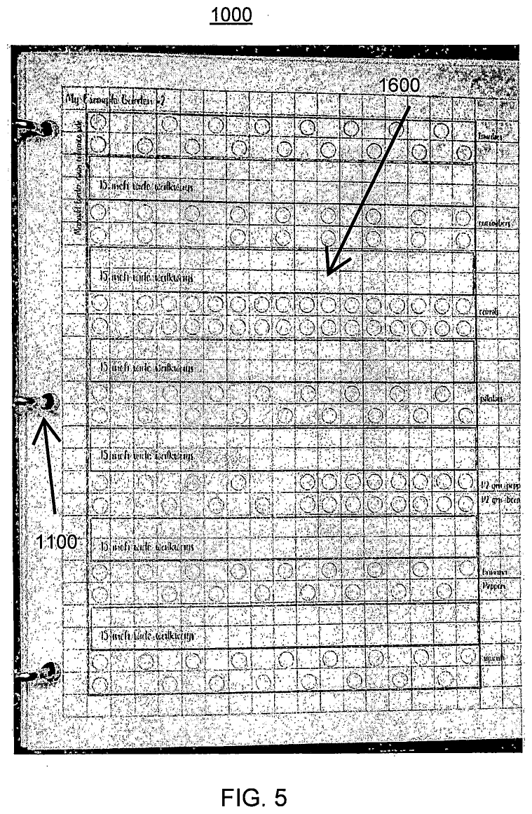

FIG. 5 is a photograph of a perspective view of exemplary embodiment 1000, which comprises an organizing section 1600 of binder 1100. Organizing section 1600 can comprise graph paper and/or sample garden designs to assist with the clean copy shape and placement of a garden and plants in the garden.

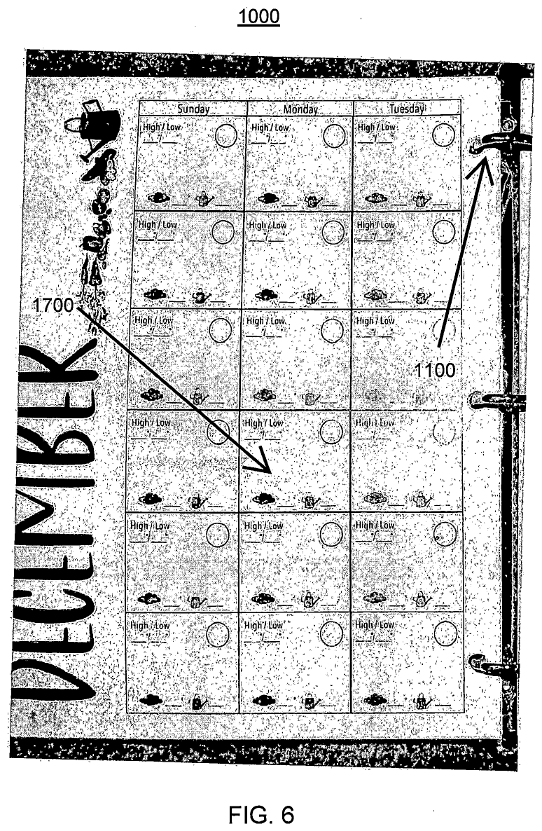

FIG. 6 is a photograph of a perspective view of exemplary embodiment 1000, which comprises a calendar section 1700 of binder 1100. Calendar section 1700 can comprise a garden specific annual monthly calendar with daily location for recording high/low temperatures, a location for tracking rainfall and/or watering schedules, and suggestions for also tracking planting schedules, harvest dates, pruning schedules, and/or first and last frost dates.

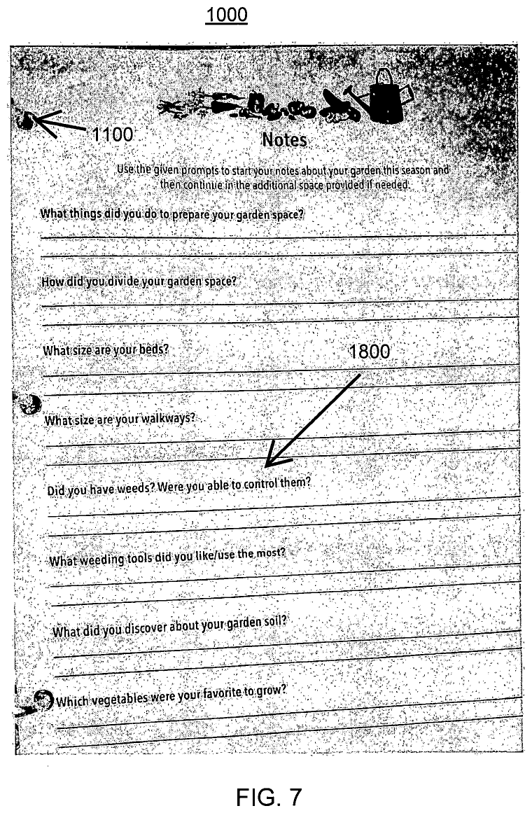

FIG. 7 is a photograph of a perspective view of exemplary embodiment 1000, which comprises a notes section 1800 of binder 1100. Notes section 1800 can comprise questions and/or notes to prompt the gardener. Notes section 1800 can comprise additional areas for notes of the gardener.

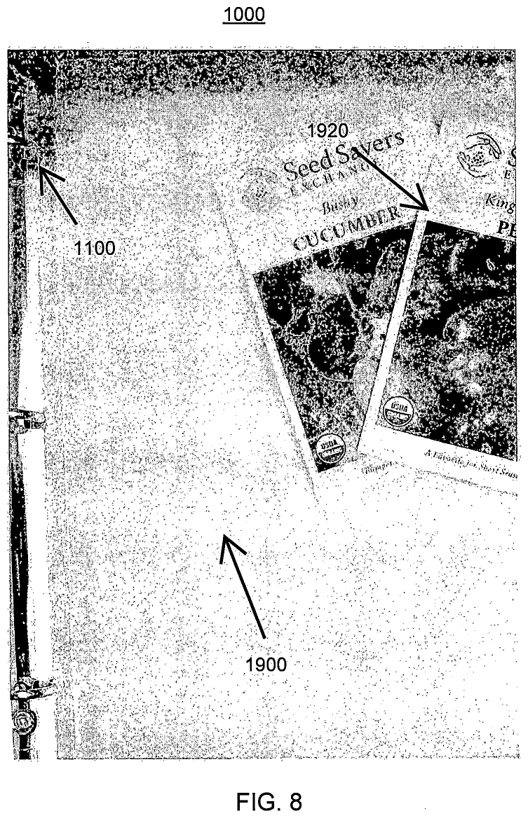

FIG. 8 is a photograph of a perspective view of exemplary embodiment 1000, which comprises a seeds section 1900 of binder 1100. Seeds section 1900 comprises a pouch 1920. Pouch 1920 is large enough to store all seeds used for by the gardener for a current season.

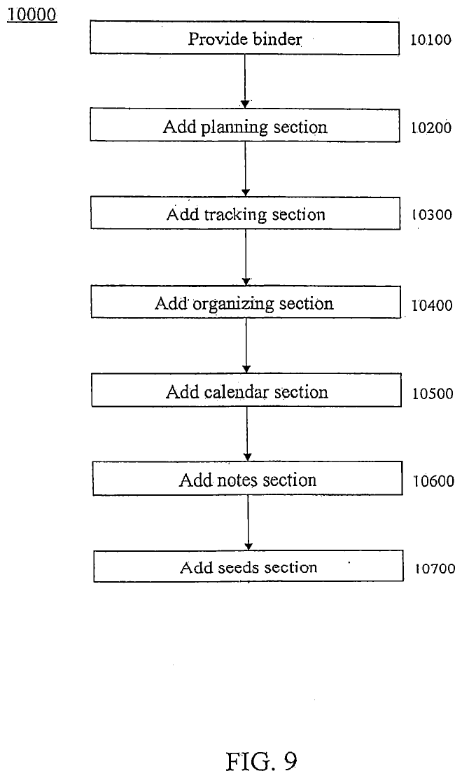

FIG. 9 is a flowchart of an exemplary embodiment of a method 10000. At activity 10100, a binder is created. The binder comprises gardening materials and methods. The binder can comprise an introductory document. The introductory document describing use of the binder.

At activity 10200, a planning section is added to the binder. The planning section comprises a plan tab. A plan page can be adjacent to the plan tab. The plan page can describe considerations of garden size and soil as to a garden. The plan page can recommend a user specify a size of the garden, a type of the garden, a soil descriptor, and/or water descriptors concerning the garden.

At activity 10300, a tracking section is added to the binder. The tracking section can comprise an expense tab. An expense page can be adjacent to the expense tab. The expense page is constructed to receive records from the user concerning costs of the garden.

At activity 10400, an organizing section is added to the binder. The organizing section can comprise a design tab. A design page can be adjacent to the design tab, the design page can describing design of the garden

At activity 10500, a calendar section is added to the binder. The organizing section can comprise a track tab. A track page adjacent to the track tab can comprise a calendar. The calendar can recommend a user specify pertinent information about the garden each day. The calendar can comprise specified locations for specifying high and low temperatures for each day. The calendar can comprise specified locations for specifying work performed in the garden each day.

At activity 10600, a notes section is added to the binder. The notes section can comprise a notes tab. A notes page can be adjacent to the notes tab, the notes page constructed to be utilized by a user to record information concerning the garden.

At activity 10700, a seeds section is added to the binder. The seeds section can comprise a pouch constructed to hold bags of seeds.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
activity—an action, act, step, and/or process or portion thereof.
adapted to—made suitable or fit for a specific use or situation.
adapter—a device used to effect operative compatibility between different parts of one or more pieces of an apparatus or system.
adjacent—lying near to something else.
and/or—either in conjunction with or in alternative to.
apparatus—an appliance or device for a particular purpose.
associate—to join, connect together, and/or relate.
bag—a flexible container constructed to be closed for holding, storing, and/or carrying objects
binder—a book constructed to hold together otherwise loose sheets of paper and/or objects.
calendar—a tabular register of days according to a system.
can—is capable of, in at least some embodiments.
comprising—including but not limited to.
concern—to pertain and/or relate to something.
configure—to make suitable or fit for a specific use or situation.
connect—to join or fasten together.
considerations—information to be considered in deciding or acting.
constructed to—made to and/or designed to.
convert—to transform, adapt, and/or change.
cosz—an amount of money paid for something.
couple—to link in some fashion.
coupleable—capable of being joined, connected, and/or linked together.
create—to bring into being.
define—to establish the outline, form, or structure of.
describe—to represent or give an account of in words and/or symbols.
descriptor—words and/or symbols that represent something.
design—to intentionally create a plan, process, or specification for the construction of an object.
determine—to obtain, calculate, decide, deduce, and/or ascertain.
device—a machine, manufacture, and/or collection thereof.
document—a physical collection of related data elements that comprises one or more sheets of paper and the related data elements printed thereon.
event—something that has happened.
expense—an outlay of funds.
garden—(n) a plot of ground where plants such as herbs, fruits, flowers, and/or vegetables are cultivated; (v) to plant and tend flora.
generate—to create, produce, give rise to, and/or bring into existence.
highest—largest in magnitude.
history—information about past events.
hold—to contain something.
information—data that has been organized to express concepts.
install—to connect or set in position and prepare for use.
introductory—an initial part of something.
location—a place substantially approximating where something physically exists.
lowest—smallest in magnitude.
materials—substances.
may—is allowed and/or permitted to, in at least some embodiments.
method—a process, procedure, and/or collection of related activities for accomplishing something.
note—a record preserved in writing.
page—a leaf, such as of paper or cardstock.
past—having existed or taken place in a period before the present.
perform—to accomplish something.
plan—a proposed method for doing or achieving something.
plurality—the state of being plural and/or more than one.
pouch—a receptacle that substantially surrounds something.
predetermined—established in advance.
provide—to furnish, supply, give, and/or make available.
receive—to get, take, acquire, and/or obtain.
recommend—to suggest, praise, commend, and/or endorse.
record—to set down in a tangible form for later reference.
repeatedly—again and again; repetitively.
request—to express a desire for and/or ask for.
section—a distinct part or portion of something.
seed—a grain or ripened ovule of a plant that will grow if sowed.
set—a related plurality.
size—how large something is.
soil—an upper layer of earth that may be dug or plowed and in which plants grow.
specify—to state explicitly.
store—to place, hold, and/or retain.
substantially—to a great extent or degree.
support—to bear the weight of, especially from below.
system—a collection of mechanisms, devices, machines, articles of manufacture, processes, data, and/or instructions, the collection designed to perform one or more specific functions.
tab—a page comprising a small flap or strip of material attached to and/or projecting from the page.
temperature—a measure of kinetic energy of a space or substance.
track—to keep a record of and/or follow something.
transmit—to send, provide, furnish, and/or supply.
type—a number of things having in common traits or characteristics that distinguish them as a group or class.
use—an act of employing something.
user—any person, organization, process, device, program, protocol, and/or system that uses a device and/or service.
utilize—to put to use.
via—by way of and/or utilizing.
water—a colorless, transparent, odorless liquid that forms the seas, lakes, rivers, and rain and is the basis of the fluids of living organisms.
work—to perform one or more tasks.

### Note

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method of determining a state of an actuator in an airplane, comprising:
reflecting incident light off of a mirror coupled to the actuator to create a reflected light, wherein a location of the mirror is dependent on the state of the actuator;
moving the mirror upon a change in the state of the actuator;
detecting a change in a parameter of the reflected light generated by moving of the mirror; and
determining the state of the actuator based on the change in the parameter.

2. The method of claim 1, wherein the mirror is coupled to the actuator via a spring, wherein the spring moves the mirror based on the state of the actuator.

3. The method of claim 2, further comprising translating a wedge via the spring to move the mirror.

4. The method of claim 2, wherein the spring is held in a non-equilibrium position by a mechanical trip indicator under normal operation of the actuator and is released by the mechanical trip indicator to relax to its equilibrium position when the actuator is over-torqued.

5. The method of claim 1, wherein the parameter of the reflected light is a phase of the reflected light.

6. The method of claim 5, further comprising detecting the change in the phase using an interferometer.

7. The method of claim 1, further comprising controlling an operation of the airplane based on the state of the actuator.

8. The method of claim 1, further comprising controlling at least one of: (i) a slat of the airplane; and (ii) a flap of the airplane.

9. An apparatus for detecting a state of an actuator in an airplane, comprising:
a mirror coupled to the actuator, wherein a location of the mirror is dependent on the state of the actuator;
a shaft for moving the mirror upon a change in the state of the actuator;
a processor configured to:
project incident light onto the mirror;
receive reflected light from the mirror;
detect a change in a parameter of the reflected light generated by moving of the mirror; and
determine the state of the actuator based on the change in the parameter.

10. The apparatus of claim 9, further comprising a spring coupled to the shaft, wherein the spring moves the shaft based on the state of the actuator.

11. The apparatus of claim 10, further comprising a wedge coupled to the shaft, wherein the wedges moves with the shaft to move the mirror.

12. The apparatus of claim 10, wherein the spring is held in a non-equilibrium position by a mechanical trip indicator under normal operation of the actuator and is released by the mechanical trip indicator to relax to its equilibrium position when the actuator is over-torqued.

13. The apparatus of claim 9, wherein the parameter of the reflected light is a phase of the reflected light.

14. The apparatus of claim 13, further comprising an interferometer configured to detect the change in the phase.

15. The apparatus of claim 9, wherein the processor is further configured to control at least one of: (i) an operation of the airplane based on the state of the actuator; (ii) a slat of the airplane; and (iii) a flap of the airplane.
